(19) United States
(12) Patent Application Publication
(10) Pub. No.: US 2022/0164818 A1
(43) Pub. Date: May 26, 2022

(54) MANAGEMENT SERVER DEVICE FOR SNS SYSTEM

(71) Applicant: SALT CO., LTD., Aichi (JP)

(72) Inventor: Toshiki SATO, Aichi (JP)

(73) Assignee: SALT CO., LTD., Aichi (JP)

(21) Appl. No.: 17/601,869

(22) PCT Filed: Feb. 12, 2020
(86) PCT No.: PCT/JP2020/005422

§ 371 Date: Oct. 6, 2021

(30) Foreign Application Priority Data
May 11, 2019 (JP) 2019-090282

(51) Int. Cl. G06Q 30/02; H04L 67/306; G06Q 50/00

(52) U.S. Cl. CPC G06Q 30/0214; G06Q 30/0246; G06Q 50/01; H04L 67/306

(57) ABSTRACT

To increase the number of views on posting information through an improvement in the quality of the posting information, and thus to improve the utilization rate of advertisement information. A management server device in an SNS system includes a posting display instructor, an advertisement display instructor, an evaluation point receiver, a posting-specific evaluation point calculator, a user-specific evaluation point calculator, a reward point calculator, a total reward point calculator, an exchange rate calculator, and an exchange rate display instructor. The reward point calculator calculates, for each of users, reward points exchangeable for money from reward resources based on user-specific evaluation points. The total reward point calculator calculates total reward points by counting the reward points given to users eligible for rewards from the reward resources. The exchange rate calculator calculates an exchange rate by dividing a reward resource amount by the total reward points. The exchange rate display instructor instructs each of user terminal devices to display the exchange rate.

### TECHNICAL FIELD

This description discloses a technique that relates to a management server device for an SNS system.

### BACKGROUND ART

In a social networking service (SNS) system for providing an SNS, a management server device is configured to exchange, through a computer network, data with user terminal devices enabled to be operated by users. The management server device receives posting information posted by the users through the user terminal devices. The management server device also instructs the user terminal devices to display a plurality of pieces of posting information posted by a plurality of users. Patent Document 1 discloses a technique for providing rewards to users based on advertising performance of advertisement information that is shown along with posting information displayed in an SNS system.

### CITATION LIST

### Patent Document

Patent Document 1: Japanese Patent No. 6283138

### SUMMARY OF THE INVENTION

### Technical Problem

It has not been sufficiently contemplated to increase the number of views on posting information through an improvement in the quality of the posting information, and thus to improve the utilization rate of advertisement information in an SNS system.

### Solution to the Problem

The technique disclosed herein can be implemented in the following forms.

(1) A management server device in one aspect disclosed herein is configured to exchange, in an SNS system, data with user terminal devices via a computer network. The user terminal devices are enabled to be operated by a plurality of users. This management server device includes: a posting receiver configured to receive a plurality of pieces of posting information posted by the plurality of users through the user terminal devices; a posting display instructor configured to instruct each of the user terminal devices to display the plurality of pieces of posting information posted by the plurality of users; an advertisement display instructor configured to instruct each of the user terminal devices to display advertisement information to be shown to the plurality of users along with the plurality of pieces of posting information displayed; an evaluation point receiver configured to receive, through each of the user terminal devices and for each of the plurality of pieces of posting information displayed on the user terminal devices, a plurality of evaluation points indicating evaluations by other users, who are not the user who created the piece of posting information; a posting-specific evaluation point calculator configured to calculate posting-specific evaluation points by counting the plurality of evaluation points for each of the plurality of pieces of posting information; a posting-specific evaluation point display instructor configured to instruct each of the user terminal devices to display the posting-specific evaluation points for each of the plurality of pieces of posting information displayed on the user terminal devices; a user-specific evaluation point calculator configured to calculate user-specific evaluation points by counting the posting-specific evaluation points for each of the plurality of users; a reward resource manager configured to manage a reward resource amount, the reward resource amount being an amount of money in reward resources accumulated from advertising fees for rewards to the plurality of users, the advertising fees being benefit for displaying the advertisement information; a reward point calculator configured to calculate, for each of the plurality of users, a plurality of reward points exchangeable for money from the reward resources based on the user-specific evaluation points; a total reward point calculator configured to calculate total reward points by counting the plurality of reward points given to the plurality of users eligible for rewards from the reward resources; an exchange rate calculator configured to calculate an exchange rate by dividing the reward resource amount by the total reward points; and an exchange rate display instructor configured to instruct each of the user terminal devices to display the exchange rate.

The management server device according to this aspect displays the exchange rate on each of the user terminal devices while avoiding a shortage of the reward resources due to an increase in evaluation points by setting the exchange rate depending on the reward resource amount and the total reward points. Thus, it is possible to increase the users' expectation for saving reward points and to reduce exchange of reward points for money from the reward resources. Furthermore, an increase in evaluation points for posting information leads to an increase in reward points. This can add an incentive for the users to improve the quality of posting information. As a result, it is possible to increase the number of views on posting information through an improvement in the quality of the posting information, and thus to improve the utilization rate (display frequency) of advertisement information.

(2) In the management server device according to the above-described aspect, the exchange rate display instructor may instruct each of the user terminal devices to display the exchange rate along with at least one of the user-specific evaluation points or the reward points of the user operating the user terminal device. The management server device according to this aspect allows the user to know the amount of money to be obtained from the reward resources as a result of an exchange, based on the evaluation points.

(3) In the management server device according to the above-described aspect, the exchange rate display instructor may instruct each of the user terminal devices to update the exchange rate displayed on the user terminal device when at least one of the total reward points or the reward resource amount is changed. The management server device according to this form allows the user to know changes in the exchange rate.

(4) In the management server device according to the above-described aspect, the reward point calculator may calculate the plurality of reward points by adding additional evaluation points to the user-specific evaluation points and subtracting, from the resultant sum, consumed points that have already been exchanged for money from the reward resources, the additional points being different from the user-specific evaluation points. The management server device according to this aspect allows determination of the reward points with the additional evaluation points and the consumed points taken into account.

(5) In the management server device according to the above-described aspect, the exchange rate calculator may set a maximum rate as an upper limit of the exchange rate, and may calculate the maximum rate as the exchange rate if a value resulting from the division of the reward resource amount by the total reward points is greater than the maximum rate. The management server device according to this aspect allows the amount of money to be substantially prevented from withdrawing from the reward resources as a result of an exchange from being overly high when the total reward points are overly small considering the reward resource amount.

(6) The management server device according to the above-described aspect further may include a user manager configured to manage each of the plurality of users in association with any one of a plurality of communal societies. In the management server device, the reward resource manager may be configured to manage the reward resource amount for each of the plurality of communal societies, the total reward point calculator may be configured to calculate the total reward points for each of the plurality of communal societies, the exchange rate calculator may be configured to calculate the exchange rate for each of the plurality of communal societies, and the exchange rate display instructor may be configured to instruct each of the user terminal devices to display the exchange rate for the communal society associated with the user operating the user terminal device. The management server device according to this aspect allows increase, on a per-communal society basis, in the number of views on posting information through an improvement in the quality of the posting information, and thus allows improvement in the utilization rate of advertisement information.

(7) In the management server device according to the above-described aspect, the evaluation point receiver may be configured to receive, through each of the user terminal devices and for each of the pieces of posting information displayed on the user terminal devices, the evaluation points indicating evaluations by other users, who are not the user who created the piece of posting information, among all users associated with a common communal society, and receive, through each of the user terminal devices and for each of the pieces of posting information displayed on the user terminal devices, the evaluation points indicating evaluations by other users associated with a second communal society differing from a first communal society associated with the user who created the piece of posting information, and the reward resource manager may be configured to transfer, upon receiving an evaluation point earned through an evaluation by another user associated with the second communal society, an evaluation amount from the reward resource amount of the second communal society to the reward resource amount of the first communal society, the evaluation amount being a product of the evaluation point earned through the evaluation by the other user and the exchange rate for the second communal society. The management server device according to this aspect enables exchange of evaluation points between different communal societies while managing the reward resources on a per-communal society basis.

The technique disclosed herein can be implemented in various aspects different from the management server device. The technique disclosed herein can be implemented, for example, in the aspect of a user terminal device, an SNS system, a management server device control method, a computer program for a management server device, a user terminal device control method, a computer program for a user terminal device, or an SNS management method.

### BRIEF DESCRIPTION OF THE DRAWINGS

FIG. 1 is an explanatory diagram illustrating an SNS system.

FIG. 2 is an explanatory diagram illustrating a specific configuration of a user terminal device.

FIG. 3 is an explanatory diagram showing an example of a community selection screen.

FIG. 4 is an explanatory diagram showing an example of a user registration screen.

FIG. 5 is an explanatory diagram showing an example of a posting display screen.

FIG. 6 is an explanatory diagram showing an example of a status screen.

FIG. 7 is an explanatory diagram illustrating a specific configuration of a management server device.

FIG. 8 is an explanatory diagram showing an operation of the SNS system.

FIG. 9 is an explanatory diagram showing an operation of the SNS system.

FIG. 10 is a flowchart showing a status update process to be performed by the management server device.

FIG. 11 is an explanatory diagram showing an operation of the SNS system.

### DESCRIPTION OF EMBODIMENTS

### A. First Embodiment

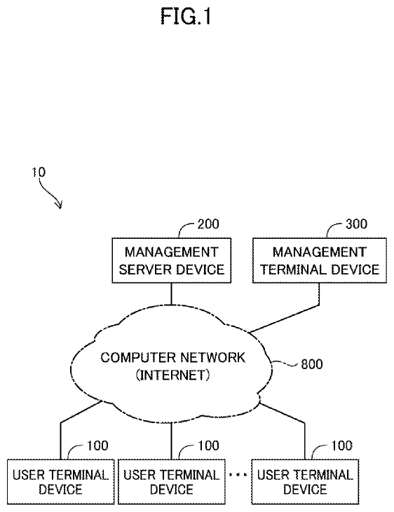

FIG. 1 is an explanatory diagram illustrating an SNS system 10. The SNS system 10 provides a social networking service (SNS). The SNS provided by the SNS system 10 enables information exchange among a plurality of users who are connected with one another using, as a unit, a community (communal society) through a tutelary deity (shrine). Each of the users in the SNS system 10 posts information to the community to which the user belongs and evaluates postings posted by other users. The SNS system 10 receives advertisements from an advertisement provider for each community. The SNS system 10 shows advertisement information to the users along with posting information. A portion of an advertising fee (e.g., 10% of the advertising fee), which is benefit for placing advertisement information on the SNS system 10, is accumulated as reward resources for rewards to the users. Each user can receive a reward from the reward resources depending on evaluations of their posting information.

The SNS system 10 includes a plurality of user terminal devices 100 and a management server device 200. The SNS system 10 further includes a management terminal device 300.

Each of the user terminal devices 100 in the SNS system 10 is a computer configured to be operated by a user. Each of the user terminal devices 100 may be any computer as long as the computer has a user interface that enables the user to use the SNS. For example, each of the user terminal devices 100 may be a smartphone, a tablet, or a personal computer.

The management server device 200 in the SNS system 10 is a computer configured to exchange data with the user terminal devices 100 via a computer network 800. The management server device 200 may be any computer as long as the computer has a server function that can provide the SNS to the users through the user terminal devices 100. In the present embodiment, the management server device 200 is a cloud server that implements a server function through cloud computing. The computer network 800 includes the Internet, a cellular phone communication network, a local area network, and a wireless local area network.

The management terminal device 300 in the SNS system 10 is a computer configured to be operated by an administrator of the SNS system 10. The management terminal device 300 may be any computer as long as the computer has a user interface that enables the administrator to input and output information to and from the management server device 200. For example, the management terminal device 300 may be a smartphone, a tablet, or a personal computer.

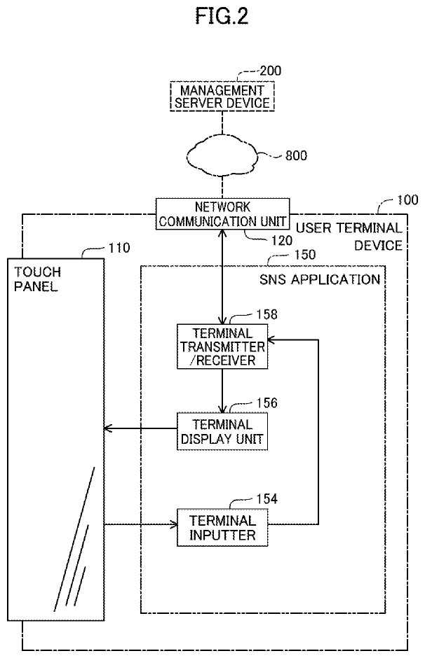

FIG. 2 is an explanatory diagram illustrating a specific configuration of a user terminal device 100. The user terminal device 100 shown in FIG. 2 as an example is a smartphone, and includes a touch panel 110 and a network communication unit 120. The touch panel 110 senses operational input of the user and displays an image thereon. The network communication unit 120 is configured to connect to the computer network 800. The network communication unit 120 has a function of connecting to the computer network 800 through a cellular phone communication network and a function of connecting to the computer network 800 through a wireless local area network.

The user terminal device 100 further includes a terminal inputter 154, a terminal display unit 156, and a terminal transmitter/receiver 158 as SNS functions for providing the SNS to the user. The terminal inputter 154 receives information from the user based on operational input of the user on the touch panel 110. The terminal display unit 156 instructs the touch panel 110 to display an image showing information outputted to the user. The terminal transmitter/receiver 158 transmits input information processed by the terminal inputter 154 to the management server device 200 through the network communication unit 120. The terminal transmitter/receiver 158 also receives output information to be processed by the terminal display unit 156 from the management server device 200 through the network communication unit 120.

The SNS functions of the user terminal device 100 are implemented in software based on SNS application 150, which is application software. At least some of configurations related to the SNS functions may be implemented in hardware based on a circuit configuration.

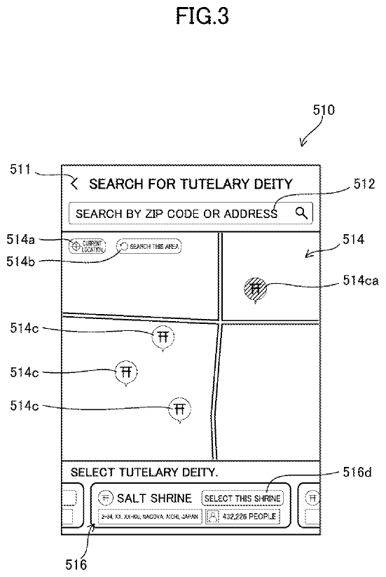

FIG. 3 is an explanatory diagram showing an example of a community selection screen 510. The community selection screen 510 receives a selection of a desired community (shrine) from the user when the user wishes to register with the SNS system 10. The community selection screen 510 is a graphical user interface (GUI) that is displayed on the touch panel 110 based on a function of the SNS application 150. The community selection screen 510 includes a transition button 511, a search box 512, a map display section 514, and a community detail display section 516.

The transition button 511 of the community selection screen 510 receives operational input from the user for a transition of the screen to a higher hierarchical level screen located one hierarchical level before the community selection screen 510. Upon the transition button 511 receiving a tapping operation of the user on the touch panel 110, the user terminal device 100 switches the screen being displayed on the touch panel 110 from the community selection screen 510 to the higher hierarchical level screen.

The search box 512 of the community selection screen 510 receives, from the user, input of a zip code or an address that specifies a place to search for a community. Upon the search box 512 receiving input of a zip code or an address from the user, the user terminal device 100 displays, in the map display section 514, a map of a place corresponding to the zip code or the address inputted in the search box 512.

The map display section 514 of the community selection screen 510 displays the map showing locations of communities and receives operational input on the map from the user. Upon the map display section 514 receiving a swipe operation of the user on the touch panel 110, the user terminal device 100 moves an area of the map being displayed in the map display section 514 in the direction of the swipe operation. Upon the map display section 514 receiving a pinch-out operation of the user on the touch panel 110, the user terminal device 100 scales up the map being displayed in the map display section 514. Upon the map display section 514 receiving a pinch-in operation of the user on the touch panel 110, the user terminal device 100 scales down the map being displayed in the map display section 514.

The map display section 514 includes a current location button 514a and a search button 514b. Upon the current location button 514a receiving a tapping operation of the user on the touch panel 110, the user terminal device 100 displays, in the map display section 514, a map of a place where the user terminal device 100 is located. Upon the search button 514b receiving a tapping operation of the user on the touch panel 110, the user terminal device 100 searches for a community (shrine) located in an area on the map being displayed in the map display section 514.

The map display section 514 can display candidate pins 514c and a selection pin 514ca. The candidate pins 514c are each a mark that indicates the location of a community (shrine) found in the area on the map being displayed in the map display section 514. The selection pin 514ca is a mark that indicates the location of a community whose detailed information is being displayed in the community detail display section 516, among the communities found in the area on the map being displayed in the map display section 514. Upon any of the candidate pins 514c receiving a tapping operation of the user on the touch panel 110, the candidate pin 514c that has received the tapping operation turns into the selection pin 514ca, and the selection pin 514ca displayed before the tapping operation turns into a candidate pin 514c. If only one community has been found in the area on the map being displayed in the map display section 514, no candidate pin 514c is displayed, and only the selection pin 514ca is displayed.

The community detail display section 516 of the community selection screen 510 displays detailed information about the community (shrine) indicated by the selection pin 514ca. The community detail display section 516 displays detailed information such as the name of the community (shrine name), the address of the community, and the total number of users belonging to the community. The community detail display section 516 has a selection confirmation button 516d. Upon the selection confirmation button 516d receiving a tapping operation of the user on the touch panel 110, the user terminal device 100 receives the community (shrine) indicated by the selection pin 514ca as a selection of the community to which the user wishes to belong.

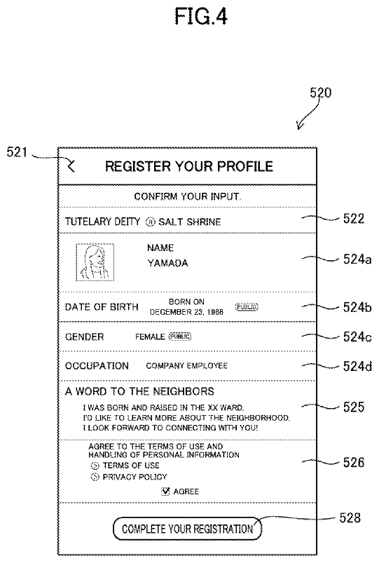

FIG. 4 is an explanatory diagram showing an example of a user registration screen 520. The user registration screen 520 receives, from the user, input of registration information of the user to be registered with the SNS system 10 when the user wishes to be registered with the SNS system 10 after having selected a desired community using the community selection screen 510. The user registration screen 520 is a graphical user interface that is displayed on the touch panel 110 based on a function of the SNS application 150. The user registration screen 520 has a transition button 521, a community display section 522, personal information input/display sections 524a to 524d, a comment input/display section 525, an agreement reception section 526, and a registration confirmation button 528.

The transition button 521 of the user registration screen 520 receives operational input from the user for a transition of the screen to the community selection screen 510, which is located one hierarchical level before the user registration screen 520. Upon the transition button 521 receiving a tapping operation of the user on the touch panel 110, the user terminal device 100 switches the screen being displayed on the touch panel 110 from the user registration screen 520 to the community selection screen 510.

The community display section 522 of the user registration screen 520 displays the community (shrine) to which the user is to belong. The community being displayed in the community display section 522 is the one selected on the community selection screen 510.

The personal information input/display sections 524a to 524d of the user registration screen 520 receive, from the user, input of personal information about the user and displays the personal information inputted. The personal information input/display section 524a receives, from the user, input of the user's name and image. The personal information input/display section 524b receives, from the user, input of the user's date of birth. The personal information input/display section 524c receives, from the user, input of the user's gender. The personal information input/display section 524d receives, from the user, input of the user's occupation.

The comment input/display section 525 of the user registration screen 520 receives, from the user, input of a comment for another user and displays the comment inputted. The agreement reception section 526 of the user registration screen 520 receives, from the user, input of the user's agreement on various terms and conditions regarding the use of the SNS through the SNS system 10.

The registration confirmation button 528 of the user registration screen 520 receives, from the user, input to register the various pieces of information inputted on the user registration screen 520. Upon the registration confirmation button 528 receiving a tapping operation of the user on the touch panel 110, the user terminal device 100 receives and transmits, to the management server device 200, the various pieces of information inputted in the community display section 522, the personal information input/display sections 524a to 524d, and the comment input/display section 525 as registration information of the user to be registered with the SNS system 10.

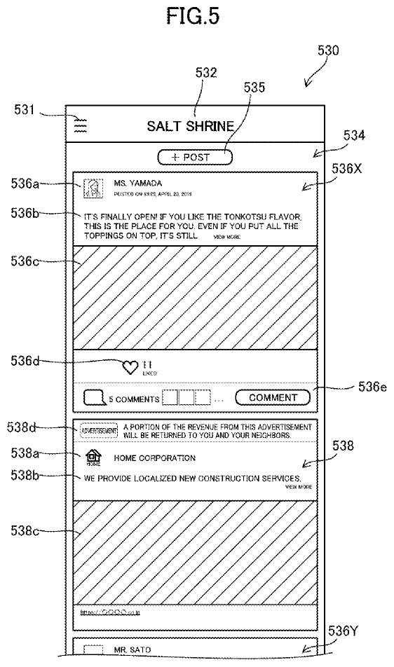

FIG. 5 is an explanatory diagram showing an example of a posting display screen 530. The posting display screen 530 displays, to the user who has been registered through the user registration screen 520, posting information and advertisement information in the community to which the user belongs. The posting display screen 530 is a graphical user interface that is displayed on the touch panel 110 based on a function of the SNS application 150. The posting display screen 530 has a menu button 531, a community display section 532, and a posting display section 534.

The menu button 531 of the posting display screen 530 is for displaying a link menu that links to a plurality of screens including the posting display screen 530 provided by the SNS application 150. Upon the menu button 531 receiving a tapping operation of the user on the touch panel 110, the user terminal device 100 displays the link menu on the posting display screen 530 in a superimposed manner.

The community display section 532 of the posting display screen 530 displays the name of the community (shrine) that has been selected as the community for which posting information is displayed on the posting display screen 530. The user can switch the community for which posting information is displayed on the posting display screen 530 by operating the menu button 531.

The posting display section 534 of the posting display screen 530 displays the posting information posted for the community (shrine) being displayed in the community display section 532. The posting display section 534 displays advertisement information placed on the community in addition to the posting information posted by the user operating the user terminal device 100 and posting information posted by other users. The posting information and the advertisement information to be displayed on the community display section 532 are selected by the management server device 200 based on a predetermined algorithm.

The posting display section 534 is configured to display various display items. The display items to be displayed in the posting display section 534 include a new posting button 535, posting information display sections 536X and 536Y, and an advertisement display section 538. The posting display section 534 displays the various display items one after another in an up-down direction. Upon the posting display section 534 receiving a swipe operation of the user on the touch panel 110, the user terminal device 100 moves the display items being displayed in the posting display section 534 in the direction of the swipe operation.

The new posting button 535 receives a new posting from the user. The new posting button 535 is displayed in the posting display section 534 when the community to which the user operating the user terminal device 100 belongs is being selected as the community for which posting information is displayed on the posting display screen 530. In other words, the user can only post information for the community to which the user belongs. Upon the new posting button 535 receiving a tapping operation of the user on the touch panel 110, the user terminal device 100 displays another screen (not shown) for receiving input of posting information from the user.

The posting information display section 536X displays posting information posted by the user operating the user terminal device 100. The posting information display section 536X has a poster display section 536a, a posting text display section 536b, a posting image display section 536c, an evaluation input/display section 536d, and a comment input/display section 536e. The poster display section 536a displays the name and the image that are registration information of the user (poster) who has posted the posting information. The posting text display section 536b displays text information posted as the posting information. The posting image display section 536c displays image information posted as the posting information. The comment input/display section 536e receives input of comments on the posting information being displayed in the posting text display section 536b and the posting image display section 536c from other users, who are not the poster. The comment input/display section 536e also displays the other users' comments.

The evaluation input/display section 536d receives input of evaluations of the posting information being displayed in the posting text display section 536b and the posting image display section 536c from the other users, who are not the poster. The evaluation input/display section 536d also displays results of the other users' evaluations. An evaluation point is given to the posting information in response to a tapping operation on a heart-shaped icon in the evaluation input/display section 536d. The evaluation point given to the posting information is canceled in response to a re-tapping operation thereon. The evaluation input/display section 536d is configured to receive, for one piece of posting information, one evaluation point from each of the other users, who are not the poster. The evaluation input/display section 536d is configured to not receive an evaluation point for posting information from the user who is the poster of the posting information. In the example shown in FIG. 5, “11” is being displayed as evaluation points in the evaluation input/display section 536d, indicating that the evaluation points have been given by 11 other users as evaluation results.

The posting information display section 536Y is the same as the posting information display section 536X except that the posting information display section 536Y displays posting information posted by a user other than the user operating the user terminal device 100. Like the posting information display section 536X, the posting information display section 536Y has a poster display section 536a, a posting text display section 536b, a posting image display section 536c, an evaluation input/display section 536d, and a comment input/display section 536e.

The advertisement display section 538 displays advertisement information placed on the community (shrine) being displayed in the community display section 532. The advertisement display section 538 has an advertiser display section 538a, an advertisement text display section 538b, an advertisement image display section 538c, and an advertisement description section 538d. The advertiser display section 538a displays the name and the logo of the advertiser who has requested the SNS system 10 to post the advertisement information. The advertisement text display section 538b displays text information placed as the advertisement information. The advertisement image display section 538c displays image information placed as the advertisement information. The advertisement description section 538d displays information indicating that the information being displayed in the advertisement display section 538 is an advertisement and that a portion of the revenue from the advertisement is returned to users.

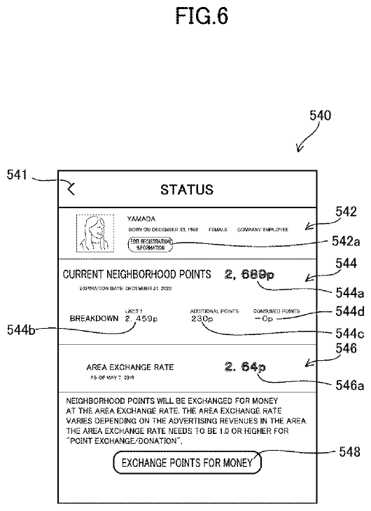

FIG. 6 is an explanatory diagram showing an example of a status screen 540. The status screen 540 displays various pieces of information related to the user. The status screen 540 is a graphical user interface that is displayed on the touch panel 110 based on a function of the SNS application 150. The status screen 540 has a transition button 541, a registration information display section 542, a point display section 544, an exchange rate display section 546, and an exchange reception button 548.

The transition button 541 of the status screen 540 receives operational input from the user for a transition of the screen to the posting display screen 530, which is located one hierarchical level before the status screen 540. Upon the transition button 541 receiving a tapping operation of the user on the touch panel 110, the user terminal device 100 switches the screen being displayed on the touch panel 110 from the status screen 540 to the posting display screen 530.

The registration information display section 542 of the status screen 540 displays registration information of the user operating the user terminal device 100. The registration information display section 542 displays the user's name, date of birth, gender, and occupation as the registration information of the user. The registration information display section 542 has a registration information edit button 542a. Upon the registration information edit button 542a receiving a tapping operation of the user on the touch panel 110, the user terminal device 100 displays another screen (not shown) for receiving editing of the registration information from the user.

The point display section 544 of the status screen 540 displays information about various types of points held by the user operating the user terminal device 100. The point display section 544 has a reward point display section 544a, an evaluation point display section 544b, an additional point display section 544c, and a consumed point display section 544d. The reward point display section 544a displays reward points held by the user operating the user terminal device 100. The reward points refer to points exchangeable for money from the reward resources. The reward points are determined as a value calculated by subtracting consumed points from a sum of user-specific evaluation points and additional evaluation points. The evaluation point display section 544b displays, as a part of a breakdown of the reward points, user-specific evaluation points calculated by counting, for each user, the evaluation points given to a plurality of pieces of posting information. The additional point display section 544c displays, as a part of the breakdown of the reward points, additional evaluation points given to the user through special offers or campaigns separately from the evaluation points given to posting information. The consumed point display section 544d displays, as a part of the breakdown of the reward points, consumed points that have already been exchanged for money from the reward resources. The various types of points displayed in the point display section 544 are updated in real time.

The exchange rate display section 546 of the status screen 540 displays information about an exchange rate at which the reward points are exchanged for money from the reward resources. The exchange rate display section 546 has a community-specific rate display section 546a. The community-specific rate display section 546a displays an exchange rate in the communal society (shrine) to which the user operating the user terminal device 100 belongs. The exchange rate displayed in the community-specific rate display section 546a is a value resulting from division of a reward resource amount, which is the amount of money in the reward resources accumulated in the communal society to which the user operating the user terminal device 100 belongs, by total reward points, which are the total of all reward points given to a plurality of users belonging to the communal society. In the present embodiment, a maximum rate can be set as an upper limit of the value of the exchange rate. If the value resulting from the division of the reward resource amount by the total reward points is greater than the maximum rate, the maximum rate is displayed as the exchange rate in the community-specific rate display section 546a. The exchange rate displayed in the exchange rate display section 546 is updated in real time.

The exchange reception button 548 of the status screen 540 receives an exchange of the reward points for money from the user. Upon the exchange reception button 548 receiving a tapping operation of the user on the touch panel 110, the user terminal device 100 displays another screen (not shown) for receiving an exchange of the reward points for money from the user.

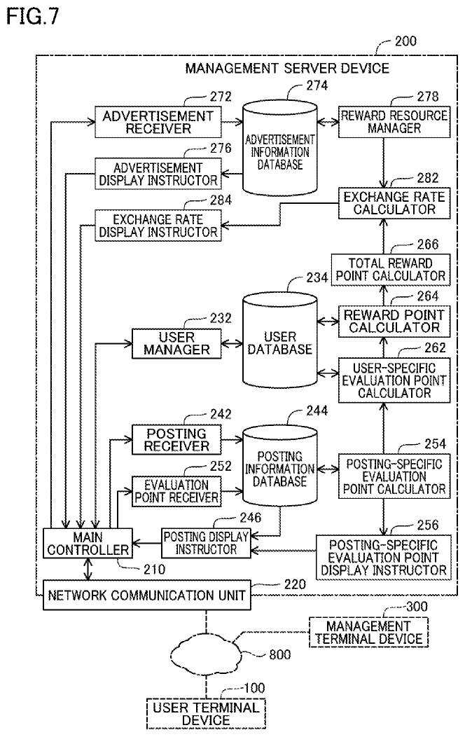

FIG. 7 is an explanatory diagram illustrating a specific configuration of the management server device 200. The management server device 200 includes a main controller 210 and a network communication unit 220. The main controller 210 controls each component of the management server device 200. The network communication unit 220 is configured to connect to the computer network 800.

The management server device 200 further includes a user manager 232 and a user database 234 as user registration-related functions. The user manager 232 manages registration information received from the users through the user terminal devices 100. The user database 234 stores the registration information of the users that is managed by the user manager 232.

The management server device 200 further includes a posting receiver 242, a posting information database 244, and a posting display instructor 246 as posting information-related functions. The posting receiver 242 receives posting information posted by the users through the user terminal devices 100. The posting information database 244 stores the posting information received by the posting receiver 242. The posting display instructor 246 instructs each of the user terminal devices 100 to display a plurality of pieces of posting information posted by a plurality of users.

The management server device 200 further includes an evaluation point receiver 252, a posting-specific evaluation point calculator 254, and a posting-specific evaluation point display instructor 256 as evaluation point-related functions. The evaluation point receiver 252 receives, through each of the user terminal devices 100 and for each of the pieces of posting information displayed on the user terminal devices 100, evaluation points indicating evaluations by other users, who are not the user who created the piece of posting information. The posting information database 244 stores the evaluation points received by the evaluation point receiver 252 in association with the posting information.

The posting-specific evaluation point calculator 254 calculates posting-specific evaluation points by counting the evaluation points for each of the pieces of posting information. The posting information database 244 stores the posting-specific evaluation points calculated by the posting-specific evaluation point calculator 254 in association with the posting information. The posting-specific evaluation point display instructor 256 instructs each of the user terminal devices 100 to display the posting-specific evaluation points for each of the pieces of posting information displayed on the user terminal devices 100 through the instruction by the posting display instructor 246.

The management server device 200 further includes a user-specific evaluation point calculator 262, a reward point calculator 264, and a total reward point calculator 266 as reward point-related functions. The user-specific evaluation point calculator 262 calculates user-specific evaluation points by counting the posting-specific evaluation points for each of the users. The user database 234 stores the user-specific evaluation points calculated by the reward point calculator 264 in association with the registration information of the user.

The reward point calculator 264 calculates, for each of the users, reward points exchangeable for money from the reward resources based on the user-specific evaluation points calculated by the user-specific evaluation point calculator 262. The user database 234 stores the reward points calculated by the reward point calculator 264 in association with the registration information of the user. In the present embodiment, the reward point calculator 264 calculates the reward points by adding additional evaluation points, which are different from the user-specific evaluation points, to the user-specific evaluation points and subtracting, from the resultant sum, the consumed points that have already been exchanged for money from the reward resources. The total reward point calculator 266 calculates the total reward points by counting the reward points given to users eligible for rewards from the reward resources.

The management server device 200 further includes an advertisement receiver 272, an advertisement information database 274, an advertisement display instructor 276, and a reward resource manager 278 as advertisement information-related functions. The advertisement receiver 272 receives advertisement information inputted by the administrator through the management terminal device 300. The advertisement information database 274 stores the advertisement information received by the advertisement receiver 272. The advertisement display instructor 276 instructs each of the user terminal devices 100 to display advertisement information to be shown to the users along with posting information displayed through the instruction by the posting display instructor 246.

The reward resource manager 278 manages the reward resource amount. The reward resource amount is the amount of money in the reward resources accumulated from advertising fees for rewards to the users. The advertising fees are benefit for displaying advertisement information. The reward resource manager 278 manages the reward resource amount based on advertising fee information included in the advertisement information received by the advertisement receiver 272.

The management server device 200 further includes an exchange rate calculator 282 and an exchange rate display instructor 284 as exchange rate-related functions. The exchange rate calculator 282 calculates the exchange rate by dividing the reward resource amount that is managed by the reward resource manager 278 by the total reward points calculated by the total reward point calculator 266. The exchange rate display instructor 284 instructs each of the user terminal devices 100 to display the exchange rate calculated by the exchange rate calculator 282. In the present embodiment, the exchange rate display instructor 284 sets the maximum rate, which is an upper limit of the exchange rate, based on an instruction from the management terminal device 300. The exchange rate display instructor 284 calculates the maximum rate as the exchange rate if the value resulting from the division of the reward resource amount by the total reward points is greater than the maximum rate.

The exchange rate display instructor 284 can instruct each of the user terminal devices 100 to display the exchange rate along with at least one of the user-specific evaluation points or the reward points of the user operating the user terminal device 100. The exchange rate display instructor 284 can instruct each of the user terminal devices 100 to update the exchange rate displayed on the user terminal device 100 when either or both of the total evaluation points and the reward resource amount is changed.

In the present embodiment, the user manager 232 manages each of the users in association with any one of a plurality of communal societies (shrines). The reward resource manager 278 manages the reward resource amount for each of the communal societies. The total reward point calculator 266 calculates the total reward points for each of the communal societies. The exchange rate calculator calculates the exchange rate for each of the communal societies. The exchange rate display instructor 284 instructs each of the user terminal devices 100 to display the exchange rate for the communal society associated with the user operating the user terminal device.

In the present embodiment, the evaluation point receiver 252 can receive, through each of the user terminal devices 100 and for each of the pieces of posting information displayed on the user terminal devices 100, evaluation points indicating evaluations by other users, who are not the user who created the piece of posting information, among all users associated with a common communal society. The evaluation point receiver 252 can also receive, through each of the user terminal devices 100 and for each of the pieces of posting information displayed on the user terminal devices 100, evaluation points indicating evaluations by other users associated with a second communal society differing from a first communal society associated with the user who created the piece of posting information. Upon receiving an evaluation point earned through an evaluation by another user associated with the second community, the reward resource manager 278 can calculate an evaluation amount by multiplying the evaluation point earned through the evaluation by the other user by the exchange rate for the second communal society, and transfer the evaluation amount from the reward resource amount of the second communal society to the reward resource amount of the first communal society.

The various functions of the management server device 200 are implemented in software based on a computer program. At least some of the various functions of the management server device 200 may be implemented in hardware based on a circuit configuration.

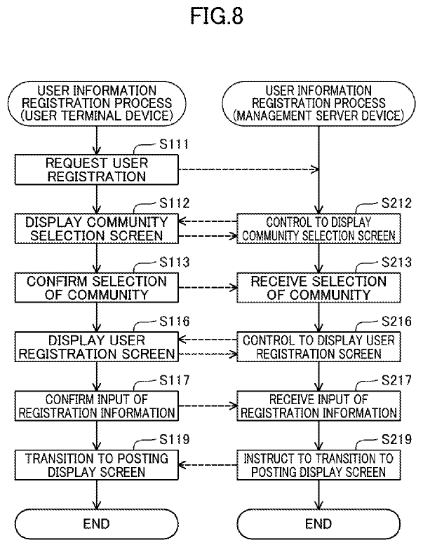

FIG. 8 is an explanatory diagram showing an operation of the SNS system 10. The left side of FIG. 8 shows a flowchart of a user information registration process to be performed by each of the user terminal devices 100. The right side of a page of FIG. 8 shows a flowchart of a user information registration process to be performed by the management server device 200.

The user terminal device 100 starts the user information registration process by causing the user manager 232 to function based on operational input from the user. After starting the user information registration process, the user terminal device 100 requests the management server device 200 to register the user with the SNS system 10 (step S111).

The management server device 200 starts the user information registration process based on the request from the user terminal device 100. After starting the user information registration process, the management server device 200 executes the control to display the community selection screen 510 on the user terminal device 100 (step S212). The user terminal device 100 displays the community selection screen 510 based on control information from the management server device 200 (step S112, see FIG. 3).

Upon the selection confirmation button 516d of the community selection screen 510 receiving a tapping operation of the user on the touch panel 110, the user terminal device 100 receives the community (shrine) indicated by the selection pin 514ca as a selection of the community to which the user wishes to belong (step S113).

After receiving the selection of the community through the user terminal device 100 (step S213), the management server device 200 executes control to display the user registration screen 520 on the user terminal device 100 (step S216). The user terminal device 100 displays the user registration screen 520 based on control information from the management server device 200 (step S116, see FIG. 4).

Upon the registration confirmation button 528 of the user registration screen 520 receiving a tapping operation of the user on the touch panel 110, the user terminal device 100 receives various registration information related to the user (step S117).

After receiving the registration information through the user terminal device 100 (step S217), the management server device 200 instructs the user terminal device 100 to cause the screen being displayed to transition from the user registration screen 520 to the posting display screen 530 (step S219). Thereafter, the management server device 200 ends the user information registration process.

The user terminal device 100 causes the screen being displayed to transition from the user registration screen 520 to the posting display screen 530 based on a control signal from the user terminal device 100 (step S119, see FIG. 5). Thereafter, the user terminal device 100 ends the user information registration process.

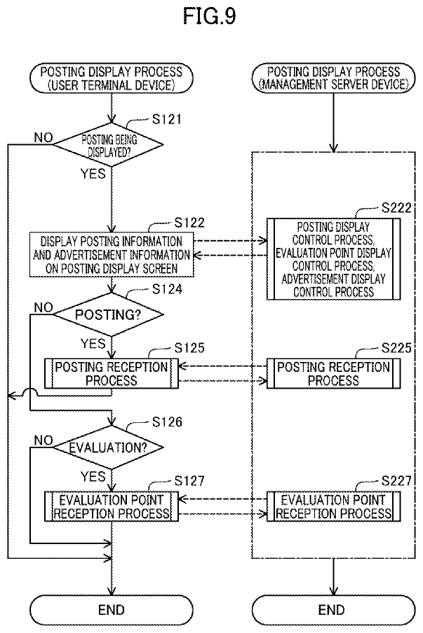

FIG. 9 is an explanatory diagram showing an operation of the SNS system 10. The left side of FIG. 9 shows a flowchart of a posting display process to be performed by each of the user terminal devices 100. The right side of a page of FIG. 9 shows a flowchart of a posting display process to be performed by the management server device 200.

The user terminal device 100 periodically starts the posting display process. After starting the posting display process, the user terminal device 100 determines whether or not the posting display screen 530 is being displayed (step S121). If the posting display screen 530 is not being displayed (step S121: “NO”), the user terminal device 100 ends the posting display process.

If the posting display screen 530 is being displayed (step S121: “YES”), the user terminal device 100 displays posting information and advertisement information on the posting display screen 530 based on a control signal from the management server device 200 (step S122, see FIG. 5).

The management server device 200 performs the posting display process when displaying the posting display screen 530 on the user terminal device 100. In the posting display process, the management server device 200 performs a posting display control process, an evaluation point display control process, and an advertisement display control process (step S222). The posting display control process causes the user terminal device 100 to display posting information based on the function of the posting display instructor 246. The evaluation point display control process causes the user terminal device 100 to display posting-specific evaluation points based on the function of the posting-specific evaluation point display instructor 256. The advertisement display control process causes the user terminal device 100 to display advertisement information based on the function of the advertisement display instructor 276.

After the posting information and the advertisement information have been displayed on the posting display screen 530 (step S122), the user terminal device 100 determines whether or not the new posting button 535 has received a tapping operation of the user on the touch panel 110 (step S124). If the new posting button 535 has received a tapping operation (step S124: “YES”), the user terminal device 100 performs a posting reception process (step S125) for receiving input of posting information from the user. After completing the posting reception process (step S125), the user terminal device 100 ends the posting display process.

While the user terminal device 100 is performing the posting reception process (step S125), the management server device 200 performs a posting reception process (step S225) for receiving the posting information from the user through the user terminal device 100 by causing the posting receiver 242 to function.

If the new posting button 535 has not received a tapping operation (step S124: “NO”), the user terminal device 100 determines whether or not the evaluation input/display section 536d has received a tapping operation of the user on the touch panel 110 (step S126). If the evaluation input/display section 536d has received a tapping operation (step S126: “YES”), the user terminal device 100 performs an evaluation point reception process (step S127) for receiving evaluation points for the posting information from users. After completing the evaluation point reception process (step S127), the user terminal device 100 ends the posting display process.

While the user terminal device 100 is performing the evaluation point reception process (step S127), the management server device 200 performs an evaluation point reception process (step S227) for receiving evaluation points from users through the user terminal device 100 by causing the evaluation point receiver 252 to function. The management server device 200 ends the posting display process in response to the user terminal device 100 ending the posting display process.

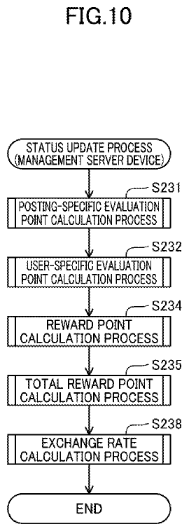

FIG. 10 is a flowchart showing a status update process to be performed by the management server device 200. The management server device 200 periodically starts the status update process.

After starting the status update process, the management server device 200 performs a posting-specific evaluation point calculation process (step S231) for calculating posting-specific evaluation points by causing the posting-specific evaluation point calculator 254 to function. The posting-specific evaluation points refer to points calculated by counting evaluation points for each of the pieces of posting information.

After completing the posting-specific evaluation point calculation process (step S231), the management server device 200 performs a user-specific evaluation point calculation process (step S232) for calculating user-specific evaluation points by causing the user-specific evaluation point calculator 262 to function. The user-specific evaluation points refer to points calculated by counting posting-specific evaluation points for each user.

After completing the user-specific evaluation point calculation process (step S232), the management server device 200 performs a reward point calculation process (step S234) for calculating reward points by causing the reward point calculator 264 to function. The reward points, which are points exchangeable for money from the reward resources, are calculated for each user based on the user-specific evaluation points.

After completing the reward point calculation process (step S234), the management server device 200 performs a total reward point calculation process (step S235) for calculating the total reward points by causing the total reward point calculator 266 to function. The total reward points refer to the total of reward points given to a plurality of users eligible for rewards from the reward resources.

After completing the total reward point calculation process (step S235), the management server device 200 performs an exchange rate calculation process (step S238) for calculating an exchange rate by causing the exchange rate calculator 282 to function. The exchange rate is a value resulting from the division of the reward resource amount by the total reward points. After completing the exchange rate calculation process (step S238), the management server device 200 ends the status update process.

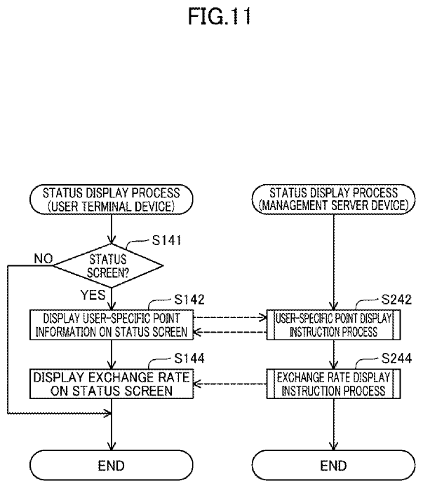

FIG. 11 is an explanatory diagram showing an operation of the SNS system 10. The left side of FIG. 11 shows a flowchart of a status display process to be performed by each of the user terminal devices 100. The right side of a page of FIG. 11 shows a flowchart of a status display process to be performed by the management server device 200.

The user terminal device 100 periodically starts the status display process. After starting the status display process, the user terminal device 100 determines whether or not the status screen 540 is being displayed (step S141). If the status screen 540 is not being displayed (step S141: “NO”), the user terminal device 100 ends the status display process.

If the status screen 540 is being displayed (step S141: “YES”), the user terminal device 100 displays user-specific point information on the status screen 540 based on a control signal from the management server device 200 (step S142, see FIG. 6). The user-specific point information includes, in addition to reward points held by the user operating the user terminal device 100, user-specific evaluation points, additional evaluation points, and consumed points as parts of the breakdown of the reward points.

After displaying the user-specific point information on the status screen 540 (step S144), the user terminal device 100 displays an exchange rate on the status screen 540 based on a control signal from the management server device 200 (step S144, see FIG. 6). The exchange rate is a value resulting from the division of the reward resource amount by the total reward points.

The management server device 200 starts the status display process when displaying the status screen 540 on the user terminal device 100. After starting the status display process, the management server device 200 performs a user-specific point display instruction process (step S242) for displaying user-specific points on the user terminal device 100 by causing the user manager 232 to function.

After performing the user-specific point display instruction process (step S242), the management server device 200 performs an exchange rate display instruction process (step S244) for displaying the exchange rate on the user terminal device 100 by causing the exchange rate display instructor 284 to function. After completing the exchange rate display instruction process (step S244), the management server device 200 ends the status display process.

According to the above-described embodiment, the management server device 200 displays the exchange rate on the user terminal device 100 while avoiding a shortage of the reward resources due to an increase in evaluation points by setting the exchange rate depending on the reward resource amount and the total reward points. Thus, it is possible to increase the users' expectation for saving reward points and to reduce exchange of reward points for money from the reward resources. Furthermore, an increase in evaluation points for posting information leads to an increase in reward points. This can add an incentive for the users to improve the quality of posting information. As a result, it is possible to increase the number of views on posting information through an improvement in the quality of the posting information, and thus to improve the utilization rate (display frequency) of advertisement information.

The management server device 200 instructs each of the user terminal devices 100 to display the exchange rate along with at least one of the user-specific evaluation points or the reward points of the user operating the user terminal device 100. Thus, it is possible to let the user know the amount of money to be obtained from the reward resources as a result of an exchange, based on the evaluation points.

The management server device 200 instructs each of the user terminal devices 100 to update the exchange rate displayed on the user terminal device 100 when at least one of the total evaluation points or the reward resource amount is changed. Thus, it is possible to let the user know changes in the exchange rate.

The management server device 200 calculates the reward points by adding additional evaluation points, which are different from the user-specific evaluation points, to the user-specific evaluation points and subtracting, from the resultant sum, the consumed points that have already been exchanged for money from the reward resources. Thus, it is possible to determine the reward points with the additional evaluation points and the consumed points taken into account.

The management server device 200 sets the maximum rate as the upper limit of the exchange rate. The management server device 200 calculates the maximum rate as the exchange rate if the value resulting from the division of the reward resource amount by the total reward points is greater than the maximum rate. Thus, it is possible to substantially prevent the amount of money to be withdrawn from the reward resources as a result of an exchange from being overly high when the total reward points are overly small considering the reward resource amount.

The management server device 200 manages the reward resource amount, the total reward points, and the exchange rate for each of the communal societies to which the users belong. Thus, it is possible to increase, on a per-communal society basis, the number of views on posting information through an improvement in the quality of the posting information, and thus to improve the utilization rate of advertisement information.

The management server device 200 receives, through each of the user terminal devices 100 and for each of the pieces of posting information displayed on the user terminal devices 100, evaluation points indicating evaluations by other users associated with a second communal society differing from a first communal society associated with the user who created the piece of posting information. Upon receiving an evaluation point earned through an evaluation by another user associated with the second communal society, the management server device 200 calculates an evaluation amount by multiplying the evaluation point earned through the evaluation by the other user by the exchange rate for the second communal society, and transfers the evaluation amount from the reward resource amount of the second communal society to the reward resource amount of the first communal society. Thus, it is possible to enable exchange of evaluation points between different communal societies while managing the reward resources on a per-communal society basis.

### B. Other Embodiments

The technique disclosed herein is not limited to the embodiment, the examples, and the variations described above, and can be implemented in a variety of configurations without departing from the gist of the technique. For example, among the technical features in the embodiment, the examples, and the variations described above, those corresponding to the technical features in the aspects described in the summary of the invention can be replaced and combined as appropriate in order to solve some or all of the problems described above or in order to achieve some or all of the effects described above. Furthermore, technical features that are not described as being essential herein can be omitted as appropriate.

For example, the management server device 200 may manage the users for each communal society or may manage all the users using a single community. The unit of the communal societies that are handled by the SNS system 10 is not limited to a tutelary deity (shrine), and may be anything that allows a certain number of users to connect with one another. The unit may be a school district, an administrative district, or a country.

### DESCRIPTION OF REFERENCE CHARACTERS

10 SNS System
100 User Terminal Device
110 Touch Panel
120 Network Communication Unit
150 SNS Application
154 Terminal Inputter
156 Terminal Display Unit
158 Terminal Transmitter/Receiver
200 Management Server Device
210 Main Controller
220 Network Communication Unit
232 User Manager
234 User Database
242 Posting Receiver
244 Posting Information Database
246 Posting Display Instructor
252 Evaluation Point Receiver
254 Posting-specific Evaluation Point Calculator
256 Posting-specific Evaluation Point Display Instructor
262 User-specific Evaluation Point Calculator
264 Reward Point Calculator
266 Total Reward Point Calculator
272 Advertisement Receiver
274 Advertisement Information Database
276 Advertisement Display Instructor
278 Reward Resource Manager
282 Exchange Rate Calculator
284 Exchange Rate Display Instructor
300 Management Terminal Device
510 Community Selection Screen
511 Transition Button
512 Search Box
514 Map Display Section
514a Current Location Button
514b Search Button
514c Candidate Pin
514ca Selection Pin
516 Community Detail Display Section
516d Selection Confirmation Button
520 User Registration Screen
521 Transition Button
522 Community Display Section
524a to 524d Personal Information Input/Display Section
525 Comment Input/Display Section
526 Agreement Reception Section
528 Registration Confirmation Button
530 Posting Display Screen
531 Menu Button
532 Community Display Section
534 Posting Display Section
535 New Posting Button
536X, 536Y Posting Information Display Section
536a Poster Display Section
536b Posting Text Display Section
536c Posting Image Display Section
536d Evaluation Input/Display Section
536e Comment Input/Display Section
538 Advertisement Display Section
538a Advertiser Display Section
538b Advertisement Text Display Section
538c Advertisement Image Display Section
538d Advertisement Description Section
540 Status Screen
541 Transition Button
542 Registration Information Display Section
542a Registration Information Edit Button
544 Point Display Section
544a Reward Point Display Section
544b Evaluation Point Display Section
544c Additional Point Display Section
544d Consumed Point Display Section
546 Exchange Rate Display Section
546a Community-specific Rate Display Section
548 Exchange Reception Button
800 Computer Network

1. A management server device configured to exchange, in an SNS system, data with user terminal devices via a computer network, the user terminal devices being enabled to be operated by a plurality of users, the management server device comprising:
a posting receiver configured to receive a plurality of pieces of posting information posted by the plurality of users through the user terminal devices;
a posting display instructor configured to instruct each of the user terminal devices to display the plurality of pieces of posting information posted by the plurality of users;
an advertisement display instructor configured to instruct each of the user terminal devices to display advertisement information to be shown to the plurality of users along with the plurality of pieces of posting information displayed;
an evaluation point receiver configured to receive, through each of the user terminal devices and for each of the plurality of pieces of posting information displayed on the user terminal devices, a plurality of evaluation points indicating evaluations by other users, who are not the user who created the piece of posting information;
a posting-specific evaluation point calculator configured to calculate posting-specific evaluation points by counting the plurality of evaluation points for each of the plurality of pieces of posting information;
a posting-specific evaluation point display instructor configured to instruct each of the user terminal devices to display the posting-specific evaluation points for each of the plurality of pieces of posting information displayed on the user terminal devices;
a user-specific evaluation point calculator configured to calculate user-specific evaluation points by counting the posting-specific evaluation points for each of the plurality of users;
a reward resource manager configured to manage a reward resource amount, the reward resource amount being an amount of money in reward resources accumulated from advertising fees for rewards to the plurality of users, the advertising fees being benefit for displaying the advertisement information;
a reward point calculator configured to calculate, for each of the plurality of users, a plurality of reward points exchangeable for money from the reward resources based on the user-specific evaluation points;
a total reward point calculator configured to calculate total reward points by counting the plurality of reward points given to the plurality of users eligible for rewards from the reward resources;
an exchange rate calculator configured to calculate an exchange rate by dividing the reward resource amount by the total reward points;
an exchange rate display instructor configured to instruct each of the user terminal devices to display the exchange rate; and
a user manager configured to manage each of the plurality of users in association with any one of a plurality of communal societies,
the reward resource manager being configured to manage the reward resource amount for each of the plurality of communal societies,
the total reward point calculator being configured to calculate the total reward points for each of the plurality of communal societies,
the exchange rate calculator being configured to calculate the exchange rate for each of the plurality of communal societies,
the exchange rate display instructor being configured to instruct each of the user terminal devices to display the exchange rate for the communal society associated with the user operating the user terminal device,
the evaluation point receiver being configured to receive, through each of the user terminal devices and for each of the plurality of pieces of posting information displayed on the user terminal devices, the plurality of evaluation points indicating evaluations by other users, who are not the user who created the piece of posting information, among all users associated with a common communal society, and receive, through each of the user terminal devices and for each of the plurality of pieces of posting information displayed on the user terminal devices, the plurality of evaluation points indicating evaluations by other users associated with a second communal society differing from a first communal society associated with the user who created the piece of posting information,
the reward resource manager being configured to transfer, upon receiving the plurality of evaluation points earned through the evaluations by the other users associated with the second communal society, an evaluation amount from the reward resource amount of the second communal society to the reward resource amount of the first communal society, the evaluation amount being a product of the plurality of evaluation points earned through the evaluations by the other users and the exchange rate for the second communal society.

2. The management server device of claim 1, wherein
the exchange rate display instructor instructs each of the user terminal devices to display the exchange rate along with at least one of the user-specific evaluation points or the reward points of the user operating the user terminal device.

3. The management server device of claim 1, wherein
the exchange rate display instructor instructs each of the user terminal devices to update the exchange rate displayed on the user terminal device when at least one of the total reward points or the reward resource amount is changed.

4. The management server device of claim 1, wherein
the reward point calculator calculates the plurality of reward points by adding additional evaluation points to the user-specific evaluation points and subtracting, from the resultant sum, consumed points that have already been exchanged for money from the reward resources, the additional points being different from the user-specific evaluation points.

5. The management server device of claim 1, wherein
the exchange rate calculator sets a maximum rate as an upper limit of the exchange rate, and calculates the maximum rate as the exchange rate if a value resulting from the division of the reward resource amount by the total reward points is greater than the maximum rate.

6. The management server device of claim 2, wherein
the exchange rate display instructor instructs each of the user terminal devices to update the exchange rate displayed on the user terminal device when at least one of the total reward points or the reward resource amount is changed.

7. The management server device of claim 2, wherein
the reward point calculator calculates the plurality of reward points by adding additional evaluation points to the user-specific evaluation points and subtracting, from the resultant sum, consumed points that have already been exchanged for money from the reward resources, the additional points being different from the user-specific evaluation points.

8. The management server device of claim 3, wherein
the reward point calculator calculates the plurality of reward points by adding additional evaluation points to the user-specific evaluation points and subtracting, from the resultant sum, consumed points that have already been exchanged for money from the reward resources, the additional points being different from the user-specific evaluation points.

9. The management server device of claim 2, wherein
the exchange rate calculator sets a maximum rate as an upper limit of the exchange rate, and calculates the maximum rate as the exchange rate if a value resulting from the division of the reward resource amount by the total reward points is greater than the maximum rate.

10. The management server device of claim 3, wherein
the exchange rate calculator sets a maximum rate as an upper limit of the exchange rate, and calculates the maximum rate as the exchange rate if a value resulting from the division of the reward resource amount by the total reward points is greater than the maximum rate.

11. The management server device of claim 3, wherein
the exchange rate calculator sets a maximum rate as an upper limit of the exchange rate, and calculates the maximum rate as the exchange rate if a value resulting from the division of the reward resource amount by the total reward points is greater than the maximum rate.

12. The management server device of claim 4, wherein
the exchange rate calculator sets a maximum rate as an upper limit of the exchange rate, and calculates the maximum rate as the exchange rate if a value resulting from the division of the reward resource amount by the total reward points is greater than the maximum rate.
